(19) United States
(12) Patent Application Publication
(10) Pub. No.: US 2012/0209856 A1
(43) Pub. Date: Aug. 16, 2012

(54) SYSTEM AND METHOD FOR ORGANIZING, ACCESSING AND MODIFYING DATA

(76) Inventors: Daniel Mckee, (US); Jason McKee, Chesapeake Beach, MD (US); Thomas Grubisich, Charleston, SC (US); Ben Jackson, London (GB)

(21) Appl. No.: 13/331,242

(22) Filed: Dec. 20, 2011

Related U.S. Application Data
(60) Provisional application No. 61/425,413, filed on Dec. 21, 2010.

(51) Int. Cl. G06F 17/30

(52) U.S. Cl. 707/748; 707/E17.033

(57) ABSTRACT

A system is provided for use with a data providing portion and first, second, and third user devices. The data providing portion can provide initial data having a plurality of data entries. The system includes a first processing portion that can generate a ranking of the data entries based on a weighting factor; a second processing portion that can provide the first user device with a first level of access and which can generate a second ranking; a third processing portion that can provide the second user device with a second level of access to one of the ranking and the second ranking; and a fourth processing portion that can provide the third user device with a third level of access to one of the ranking and the second ranking.

The present application claims priority from U.S. Provisional Application No. 61/425,413 filed Dec. 21, 2010, the entire disclosure of which is incorporated herein by reference.

### BACKGROUND

Ranking or judging aspects of companies and places has long been commonplace. With the advent of the Internet and Internet accessible smart phones, people now are able to quickly find comments, or ranking of most anything—restaurants, universities, cities, etc. However, conventional Internet obtainable rankings are static—they are created based on a static aspect at a static time.

What is needed is a system and method that enables dynamic Internet obtainable rankings.

### BRIEF SUMMARY

The present invention provides a system and method that enables dynamic Internet obtainable rankings.

In accordance with aspects of the present invention, a system is provided for use with a data providing portion, a first user device, a second user device and a third user device. The data providing portion can provide initial data having a plurality of data entries. The system includes a first processing portion, a second processing portion, a third processing portion and a fourth processing portion. The first processing portion can generate a ranking of the plurality of data entries based on a predetermined weighting factor. The second processing portion can provide the first user device with a first level of access to the ranking, can change one of the plurality of data entries, the ranking and the predetermined weighting factor and can generate a second ranking based on the changed one of the plurality of data entries, the ranking and the predetermined weighting factor. The third processing portion can provide the second user device with a second level of access to one of the ranking and the second ranking. The fourth processing portion can provide the third user device with a third level of access to one of the ranking and the second ranking

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates an example system for organizing, accessing an modifying data in accordance with aspects of the present invention;

FIG. 2 illustrates an example data managing portion of FIG. 1;

FIG. 3 illustrates an example processing portion of the data managing portion of FIG. 2;

FIG. 4 illustrates another example processing portion of the data managing portion of FIG. 2;

FIG. 5 illustrates another example processing portion of the data managing portion of FIG. 2;

FIG. 6 illustrates another example processing portion of the data managing portion of FIG. 2;

FIG. 7 is a flow chart describing an example method of organizing, accessing an modifying data in accordance with aspects of the present invention; and

FIG. 8 illustrates another example system for organizing, accessing and modifying data in accordance with aspects of the present invention.

### DETAILED DESCRIPTION

The present invention uses open data, mathematics and journalism to provide a profile of communities. A formula used by a system in accordance with aspects of the present invention turns data into knowledge. This is achieved through a unique system composed of three major parts: an automated data analysis formula, a network of professional journalists, and customers—the end-user.

The result is a contextualized and rated profile of a plurality of communities, no matter how small or large. The rating is contextualized—or put into context for each individual user—using four levels of analysis. These four tiers provide a credible and customized community rating for all users.

The first layer, in accordance with the present invention, includes automated data analysis. Data that is specific to individual communities is first identified. Then the data is rated based on weighting factors for variables within particular data categories.

For example, in the category of Education for Reston, Va., an example system in accordance with aspects of the present invention may collect 25 data points. These may include teacher to student ratio, budget dollars spent per student, graduation rates and incidents of truancy, among others. Using a scientific, research-based approach to the value of each of these data points, the system assigns weight to each one. When the data is analyzed using this weighted analysis, a rating for the category of Education in the community of Reston, Va., is produced. This rating is based on raw data only. It has not yet been put into context for a user in Reston. To do this, three additional layers of analysis arc needed. All three of these are provided by people inside the community.

The first is provided by a network of journalists, each familiar with the community they have been hired to cover. Using the disciplines of their trade: objectiveness, fairness and access—not only to the community's hired and elected leaders, but also to the taxpaying residents themselves—the journalist acts as the second layer of analysis.

This human involvement is crucial in providing an accurate profile and rating of any community. A journalist covering Tulsa, Okla., for example, will log into a system in accordance with an aspect of the present invention and see the rating for Tulsa produced by the algorithm. The journalist will see an overall rating for the community. The journalist will also see a rating for each data category which has produced that overall rating. These categories may include such things as Healthcare, Dining Out, Parks and Recreation, Mobility, Public Safety, Cost of Living, Tax Rates, etc. The journalist will also have access to every data point used to produce the category ratings. So if the system captured 12 data points to produce its rating on Public Safety in Tulsa, the journalist will have access to each data point.

It may be the responsibility of the journalist—in addition to being a representative for the residents of the community they cover—to analyze the ratings produced by the automated system. The journalist, familiar with Tulsa, may see that the Public Safety rating is very low. This would indicate a high rate of crime. It is possible the journalist feels Tulsa is quite safe, and that the Public Safety category rating does not accurately reflect the crime rate in Tulsa. The journalist would then flag the rating, which sends a signal to a system management team that there is a possible anomaly in the rating.

This type of anomaly could be the result of inaccurate data collected by the system. For instance, the source, or publisher of a particular data set may have collected or displayed incorrect information. Or a third party may have accessed and corrupted the data. The journalist would identify this data point and flag it. Someone would investigate the problem. If the data point were found to be inaccurate or corrupt it would be corrected or removed from the formula.

This type of anomaly could also be the result of something more complicated, that is, something only someone familiar with Tulsa would know. This is why a system in accordance with aspects of the present invention may contextualize the data in the first place, to make it not only accurate but relevant for users. For instance, it may be that Tulsa has one of the lowest crime rates in the country, but that in the previous year a single armed robber successfully robbed seven banks before being caught by the police. The data, if produced annually, would then reflect inordinately high incidents of robbery for Tulsa. But if the data were more recent it would show that the crime was the work of a single individual, that the individual has been apprehended, and that the crime rate before the spree of robberies was the nation's lowest, and has now returned to that level since the arrest of the bank robber.

Some of the data points will be in real time, eliminating such anomalies. And as the online data movement progresses, this will be more so. But there will always be some data which is outdated or not reflective of recent events which may skew the system's automated rating to some degree. In the example of a lone bank robber in Tulsa, the journalist will spot the anomaly and provide a corrective explanation of the discrepancy. New data, based on the journalist's input, will then be fed into the formula, reflecting the true state of Public Safety in Tulsa.

At this stage, the system provides an accurate, credible analysis of all communities in America. But the technology available enables a system in accordance with the present invention to add at least two more layers of contextualization. These are generated by the people most interested in the community ratings—the community residents.

Users of a system in accordance with the present invention will be able to put themselves into the formula. This could be done by ranking the categories in terms of importance according to their lifestyle. For example, a user in Mountain View, Calif. may be most interested in Employment, Housing, Dining Out and Nightlife. The remaining categories would then be given far less weight in determining the overall rating for Mountain View for that particular user. For example, if the system is based on a number format of 0 to 5, 0 being the lowest rating and 5 being the most favorable, Mountain View may have received a 3.9 overall rating. But if the user selects four categories most important to them, the ratings of those particular categories are now fed back into the algorithm to provide a new overall rating. The system may then, for instance, produce a Mountain View rating for this user to a 4.6. That is a customized rating, relevant only to that particular user. This is putting the data into context at the individual level.

Aspects of the present invention also recognize the power of crowd generated data, and the efficiency of social networking tools. For these reasons, another layer is added into the mix. This layer of contextualization is generated by users deemed Local Experts by the company.

This is achieved by extending to each user a fixed or variable level of trust. For example, if a user in Charlotte, N.C., provides feedback or input in response to the system's Education rating, that user may be asked to become a Local Expert. This user's input will then affect, to some degree, the rating of that category for that community. This input will be measured against other input by Local Experts of that category for that community. This enables a system in accordance with aspects of the present invention to use crowd sourced data to enhance ratings. It also enables a system in accordance with aspects of the present invention to monitor for a certain level of standard deviation. If a user's input is found to be contrary to other users in terms of input, that user will be flagged. The journalist in that community will then look into the matter and decide if there is some legitimate reason for the deviation. This filter enables a system in accordance with aspects of the present invention to protect the credibility of ratings, while at the same time encouraging community residents to become part of the process of contextualization.

A system in accordance with aspects of the present invention may exist on the web and smart phone platforms. Its ratings may be published in numerous formats, including numbers, colors, graphs, charts and data visualizations. Its data and its process will be completely transparent to the user. Users may drill down into the overall rating of a community by viewing the individual category ratings. Users may drill further, to the numerous data points used to compile ratings for each category. Users will also have access to the ratings of categories, and the overall ratings, of communities outside their own.

In an example embodiment, users will not have access to the weights applied to each data point, or to the weight given to the input of the journalists, or to the weight given to the input provided by the users themselves, as that formula provides a system in accordance with aspects of the present invention a major component of its value, retains the integrity of the ratings and will therefore remain protected by the company.

The confluence of three major events have made a system in accordance with aspects of the present invention possible. The first is the online data movement. Now, and more so in the future, data will be available online, freely and in real time, allowing the average citizen access to a wealth of information once protected by governments and high-priced databanks. The volume of information will increase, but it will overwhelm the average Internet user. This wealth of information needs to be collected, analyzed and put into context to be relevant for the average citizen.

The second major event is the explosive growth in the smart phone market over the past several years. This trend has made computing portable, much more so than the laptop computer. Applications for these devices have created a market of their own. To capitalize on this handheld computing power and new emerging market, a system in accordance with aspects of the present invention will deliver its treasure trove of knowledge to phones across the country.

The third major event paving the way for a system in accordance with aspects of the present invention is the decline of the newspaper industry. As print costs increase and free digital classified ads make it more cost prohibitive to publish newspapers, the small papers find themselves squeezed out of business. This has left a gap in the local news market, or “hyperlocal” market, as it is now known.

Small communities relied on their local paper to deliver relevant news and information. The larger, national publications stay afloat by cutting staff and reducing the size of their pages and increasing the costs of their ads, but the small papers arc unable to do this successfully. The current state of the industry is that the small papers still operating are doing so at the cost of robbing their readers of content. If someone were to produce quality, relevant content at the hyperlocal level the readers would be drawn to it. Quality content informs readers. It tells the story of their community. The Washington Post can speak for Washington, D.C. But it is not doing so well speaking for the average reader in Bethesda, Md., who is, naturally, more interested in what's going on in Bethesda than in Washington.

In addition to providing contextualized data and community ratings for these hyperlocal communities, a system in accordance with aspects of the present invention will provide quality content. The journalists hired to monitor the data ratings and act as the system's second layer of contextualization will also be tasked with producing locally relevant news articles for the community(ies) to which they are assigned.

These news articles will be generated, in part, by the same system that is rating the community. This may be achieved by software or hardware that is designed to monitor the historical analyses of several different types of data. For example, let's say, hypothetically, that water usage in the town of Severna Park, Md., is 75,000 gallons per resident per year. Recent Water Department data collected and analyzed by a system in accordance with aspects of the present invention shows water consumption increased lasts year to more than 200,000 gallons per resident per year. This type of information will be recognized by the software or hardware, which will then automatically flag the data and alert the journalist covering Severna Park.

After a few phone calls the journalist may learn an underwater main had been damaged by a highway construction crew. The water main was cracked but continued to operate. The Water Department learned of the increase in water usage immediately but was unable to locate the problem. The director of the department decided to keep the matter secret. It took the department two months to find the problem, resulting in the increase in overall water usage. Because the local paper is understaffed, no one was there when the town council discussed the issue. No one noticed the problem until a system in accordance with aspects of the present invention flagged the deviation, and once that occurred, a reporter was on the scene to write the story.

This ability to not only evaluate the efficiency and livability of communities but to produce relevant news articles for those communities is where a news distribution service comes into play.

Filling the hyperlocal news gap will be a network of journalists. Enabling them to produce relevant news more accurately, and more efficiently than traditional publishers, is the data system collecting, analyzing and pushing information directly to the journalist.

This can have benefits for small communities and large. For instance, if a small suburban community started to increase salaries for its council members, mayor, zoning officers and borough manager, the residents may not find out. If there is no local news service such things can slip through the cracks, as was the case recently in Bell, Calif., when it was learned that city officials had been giving themselves annual salaries upwards of $700,000. Bell is like thousands of other communities. It lies outside the city limits of a major city so its residents read the national publication, in this case the L.A. Times. But the L.A. Times cannot afford to cover all of the city's more than 200 suburban communities. It was in this gap that city officials were able to authorize themselves bloated salaries and waste the tax dollars paid by the hardworking residents of Bell.

A news service allows the company to create custom news for all communities. These articles will be published, distributed or sold, or they will be licensed to other news providers or publishers. They will amount to the world's first nationwide local news service, a network of journalists across the country, each with access to a wealth of analyzed, contextualized data relevant to the readers in their specific coverage area.

The entire system operates from the increasing flow of online data. Thousands of data points are captured. The system recognizes locations inside the data, and is therefore able to direct it to the appropriate community. The system weighs each data point in each category to produce a rating. The ratings of all the categories are crunched into another formula and an overall community rating is determined. That rating is then evaluated by the journalist. After that it is published to the community. Users in that community have the opportunity to qualify as Local Experts and provide their own input on the ratings. They are also able to provide their own preferences, marking some categories more important than others, and subsequently changing the overall rating of their town to an overall rating of their town for them specifically.

As this proceeds the system is generating leads for possible stories by marking rapid and drastic changes in the historical analysis of certain data points. These leads are delivered to the journalist in the appropriate community and investigated, producing locally relevant content. This content is then published, licensed or sold.

The online data movement, the ubiquitous smart phone and the decline of the local newspaper all combine to create the tools, and the market, for such a system to be developed. A system in accordance with aspects of the present invention, however, is the first such kind to be proposed.

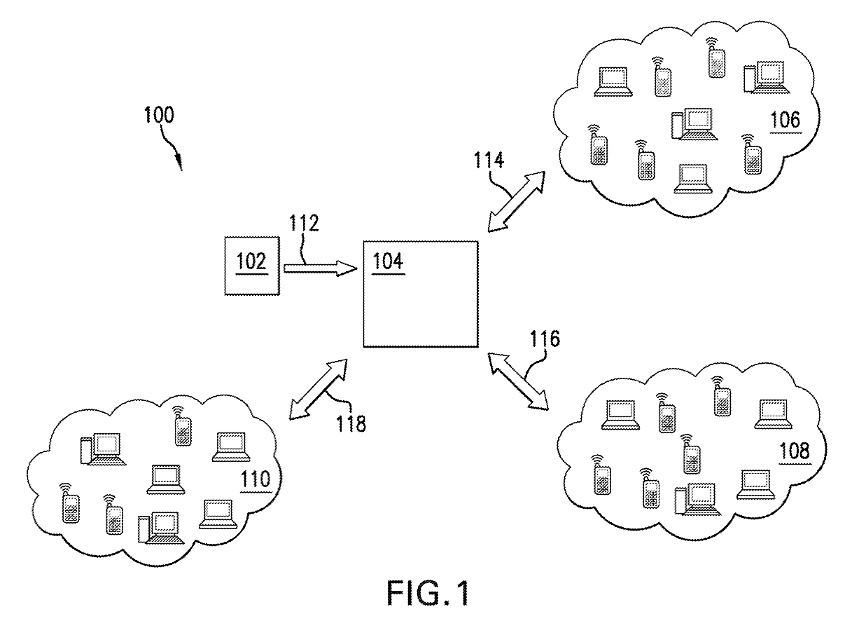

An example system in accordance with aspects of the present invention will now be described with reference to FIGS. 1-8.

FIG. 1 illustrates an example data system 100 for organizing, accessing and modifying data in accordance with aspects of the present invention. Data system 100 includes a data providing portion 102, a data managing portion 104, a journalist network 106, an expert network 108 and an end user network 110. Data providing portion 106 can provide data to data managing portion 104 via any known communication method or system, as illustrated by arrow 112. Journalist network 106 can access data, change data and/or change the data organizing algorithm within data managing portion 104 via any known communication method or system, as illustrated by arrow 114. Expert network 108 can access data, change data and/or change the data organizing algorithm within data managing portion 104 via any known communication method or system, as illustrated by arrow 116. End users network 110 can access data and/or change the data organizing algorithm within data managing portion 104 via any known communication method or system, as illustrated by arrow 118.

As discussed above, data providing portion 102 provides initial data to data managing portion 104. Any data may be included, non-limiting examples of which include school rankings, income levels, population types, etc. The data may be of little use to an end user, unless it is arranged. Data managing portion 104 arranges, classifies and/or ranks the data for use by the end-user.

As further mentioned above, journalists (or one or more other approved entities, such as bloggers, community organizers, and the like) may access the data organized by data managing portion 104. For example, a journalist from network of journalists 106 may have a predetermined type of access to the data within data managing portion 104 and/or access to the algorithm used by data managing portion 104. As such, a journalist may alter the originally organized data if needed.

A local expert also may access the data organized by data managing portion 104. For example, an expert from network of experts 108 may have a predetermined type of access to the data within data managing portion 104 and/or access to the algorithm used by data managing portion 104. This level of access may be the same, or different, from the level of access as provided to network of journalists 106. As such, an expert may additionally alter the originally organized data if needed.

Finally, an end-user may access the data organized by data managing portion 104. For example, an end-user from network of end-users 110 may have a predetermined type of access to the data within data managing portion 104 and/or access to the algorithm used by data managing portion 104. This level of access may be the same, or different, from the level of access as provided to network of journalists 106 and the level of access as provided to network of experts. As such, an end-user may additionally alter the originally organized data if needed.

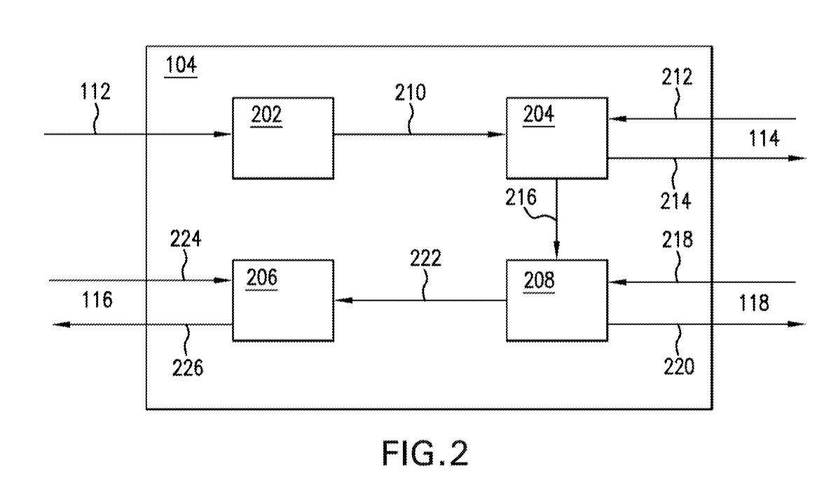

FIG. 2 illustrates data managing portion 104 of FIG. 1. Data managing portion 104 includes a processing portion 202, a processing portion 204, a processing portion 206 and a processing portion 208. In this embodiment, each of processing portion 202, processing portion 204, processing portion 206 and processing portion 208 are illustrated as distinct devices. However, in other embodiments, at least two of processing portion 202, processing portion 204, processing portion 206 and processing portion 208 may be combined as a unitary device. Further, in some embodiments, at least one of processing portion 202, processing portion 204, processing portion 206 and processing portion 208 may be implemented as a tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a tangible computer-readable medium. Thus, any such connection is properly termed a tangible computer-readable medium. Combinations of the above should also be included within the scope of tangible computer-readable media.

Processing portion 202 may receive data from data providing portion 102 and process the data based on a predetermined or variable algorithm. The algorithm may organize the data based on weighting factors. In particular, each data entry may be multiplied by a weighting factor to determine an overall ranking. Further, the algorithm may include relationships between types of data. For example, a quality of life ranking may be based on a relationship between local tax data, crime data and median income data. Then processing portion 202 may then provide the organized data 210 to processing, portion 204.

Processing portion 204 may then provide a journalist from network of journalists 106 access to organized data 210 via any known communication method or system, as indicated by line 214. If the journalist determines that some of the data is incorrect, or the ranking is incorrect, the journalist may alter the organized data via any known communication method or system, as indicated by lint 212. In particular, processing portion 204 may additionally change the actual value of a data entry within the organized data and/or may alter the algorithm based on instruction from the journalists. For example, if the journalist determines that the crime rate indicated in organized data 210 is incorrect, then journalist may correct the data value. Further, if the journalists determines that the crime rate has been given too large an influence within the quality of life ranking (the weighting factor of the crime rate is too high), then journalist may alter the algorithm used to organize the data. Then processing portion 204 may then provide the organized data 216 to processing portion 208.

Processing portion 206 may then provide an expert from network of experts 108 access to organized data 216 via any known communication method or system, as indicated by line 220. If the expert determines that some of the data is incorrect, or the ranking is incorrect, the expert may alter the organized data via any known communication method or system, as indicated by line 218. In particular, processing portion 206 may additionally change the actual value of a data entry within the organized data and/or may alter the algorithm based on instruction from the expert. Then processing portion 206 may then provide the organized data 222 to processing portion 208.

Processing portion 208 may then provide an end-user from network of end-users 110 access to organized data 222 via any known communication method or system, as indicated by line 224. If the end user wants a particular data set he may request it via any known communication method or system, as indicated by line 224. In particular, processing portion 208 may additionally change or remove data entries within the organized data and/or may alter the algorithm based on instruction from the end user. For example, if the end user determines that he is not concerned about the quality of schools, but is interested in the quality of restaurants, then end user may request that all data relating to the quality of schools not be used to determine the organization of the data.

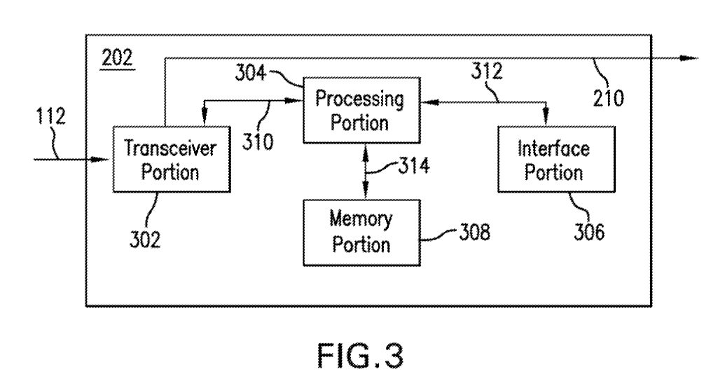

FIG. 3 illustrates processing portion 202 of the data managing portion 104 of FIG. 2. Processing portion 202 includes a transceiver portion 302, a processing portion 304, an interface portion 306 and a memory portion 308. In this embodiment, each of transceiver portion 302, processing portion 304, interface portion 306 and memory portion 308 are illustrated as distinct devices. However, in other embodiments, at least two of transceiver portion 302, processing portion 304, interface portion 306 and memory portion 308 may be combined as a unitary device. Further, in some embodiments, at least one of transceiver portion 302, processing portion 304, interface portion 306 and memory portion 308 may be implemented as a tangible computer-readable media for carrying or having computer-executable instructions or data structures stored thereon.

Transceiver portion 302 may be able to transmit and receive information by any known method, non-limiting examples of which include wireless and wired, as indicated by line 112. Transceiver portion 302 may receive data from data providing portion 102. Transceiver portion 302 may than provide the data to processing portion 304 by any known method, non-limiting examples of which include wireless and wired, as indicated by line 310.

Processing portion 304 includes an original algorithm for arranging the data into an original format. For example, the original algorithm may use X aspects, wherein X is a positive integer greater than 0. Aspects may be types of data used to quantify a locality, non-limiting examples of aspects include median income, crime rate, number of restaurants, etc.

The algorithm then applies weighting factors to each aspect. For example, in an example system design wherein the system designer considers crime to be more important than median income, then the crime aspect will be given a larger weighting factor than the weighting factor for median income.

Once all the aspects arc calculated, the data is arranged in a predetermined manner. In an example embodiment, the data is arranged in an order based on a decreasing raw score of the products of each aspect and its corresponding weighting factor. For example, for purposes of discussion, a locality Greenacre may be listed as a better locality than Redacre, based on the sum of the products of each data value (for each aspects) and the corresponding weighting factors.

Once the data is arranged, it processing portion 304 may provide the arranged data to memory portion 308 by any known method, non-limiting examples of which include wireless and wired, as indicated by line 314.

Interface portion 306 enables a system designer to create and or modify the algorithm within processing portion 304. Non-limiting examples of interface portion 306 include a keyboard, mouse and graphical user interface. Interface portion 306 may instruct processing portion 304 (for example, to create and or modify the algorithm) by any known method, non-limiting examples of which include wireless and wired, as indicated by line 312.

Memory portion 308 is operable to store data, such as the data as received from data providing portion 102 and the data organized by processing portion 304. Finally, memory portion 308 is able to provide the data organized by processing portion 304 to transceiver portion 302, based on an instruction from processing portion 304. In this manner, the organized data may be provided to processing portion 204 as indicated by line 210.

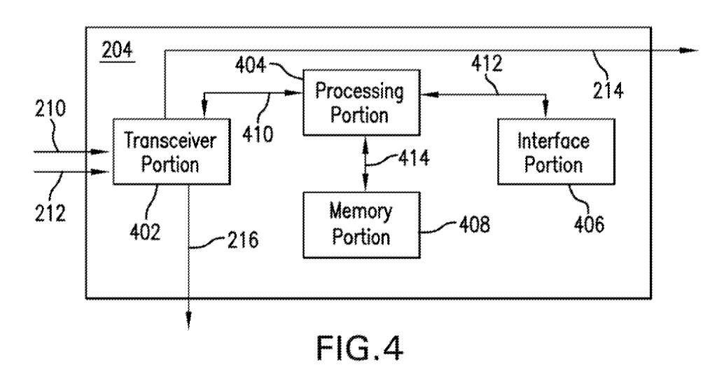

FIG. 4 illustrates processing portion 204 of the data managing portion 104 of FIG. 2. Processing portion 204 includes a transceiver portion 402, a processing portion 404, an interface portion 406 and a memory portion 408. In this embodiment, each of transceiver portion 402, processing portion 404, interface portion 406 and memory portion 408 are illustrated as distinct devices. However, in other embodiments, at least two of transceiver portion 402, processing portion 404, interface portion 406 and memory portion 408 may be combined as a unitary device. Further, in some embodiments, at least one of transceiver portion 402, processing portion 404, interface portion 406 and memory portion 408 may be implemented as a tangible computer-readable media for carrying or having computer-executable instructions or data structures stored thereon.

Transceiver portion 402 may be able to transmit and receive information by any known method, non-limiting examples of which include wireless and wired. Transceiver portion 402 may receive organized data from processing portion 202, as indicated by line 210. Transceiver portion 402 may than provide the organized data to processing portion 404 by any known method, non-limiting examples of which include wireless and wired, as indicated by line 410. Transceiver portion 402 may additionally provide the data from processing portion 202 to network of journalists 106, as indicated by line 214.

For purposes of discussion, suppose a journalist from network of journalists 106 disagrees with a data entry within the organized data from processing portion 202, or disagrees with the weighting factor, e.g., the journalist believes that the level of crime within a locality is more important than the median income. In such a case, the journalist will have an ability to change the data or change the algorithm. Processing portion 404 will recognize a level of access that the journalist has been provided. This access may be established by way of any known security method or system. Once recognized, processing portion 204 will enable a journalist to change a data entry or the algorithm. As such the organized data from processing portion 202 will now be reorganized or changed, based on the changes made by the journalist.

Processing portion 404 includes the original algorithm as was provided in processing portion 304 of FIG. 3, for arranging the data into an original format. However, as mentioned above, processing portion 404 may be able to modify the algorithm based on input from a journalist from network of journalists 106.

Interface portion 406 enables a system designer to create and or modify the algorithm within processing portion 404. Non-limiting examples of interface portion 406 include a keyboard, mouse and graphical user interface. Interface portion 406 may instruct processing portion 404 (to create and or modify the algorithm) by any known method, non-limiting examples of which include wireless and wired, as indicated by line 412.

Memory portion 408 is operable to store data, such as the data as received from processing portion 202 and the data organized by processing portion 404. Finally, memory portion 408 is able to provide the data organized by processing portion 404 or the reorganized data (as reorganized by processing portion 404 based on instructions from network of journalists 106) to transceiver portion 402, based on an instruction from processing portion 404. In this manner, the organized data may be provided to processing portion 206 as indicated by line 216.

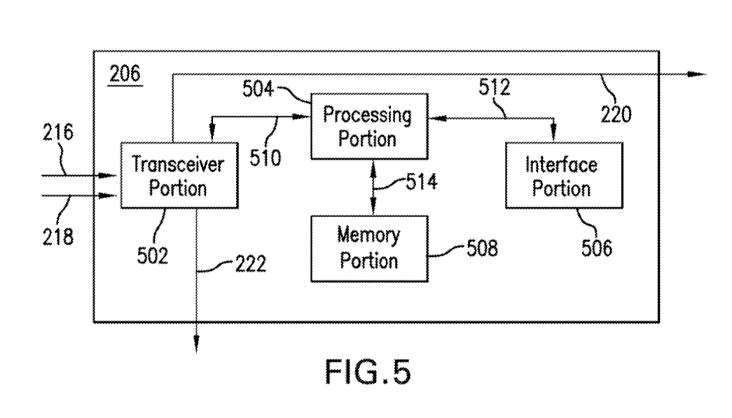

FIG. 5 illustrates processing portion 206 of the data managing portion 104 of FIG. 2. Processing portion 206 includes a transceiver portion 502, a processing portion 504, an interface portion 506 and a memory portion 508. In this embodiment, each of transceiver portion 502, processing portion 504, interface portion 506 and memory portion 508 are illustrated as distinct devices. However, in other embodiments, at least two of transceiver portion 502, processing portion 504, interface portion 506 and memory portion 508 may be combined as a unitary device. Further, in some embodiments, at least one of transceiver portion 502, processing portion 504, interface portion 506 and memory portion 508 may be implemented as a tangible computer-readable media for carrying or having computer-executable instructions or data structures stored thereon.

Transceiver portion 502 may be able to transmit and receive information by any known method, non-limiting examples of which include wireless and wired. Transceiver portion 502 may receive reorganized data from processing portion 204, as indicated by line 216. Transceiver portion 502 may than provide the reorganized data to processing portion 504 by any known method, non-limiting examples of which include wireless and wired, as indicated by line 510. Transceiver portion 502 may additionally provide the data from processing portion 204 to network of experts 108, as indicated by line 220.

For purposes of discussion, suppose an expert from network of experts 108 disagrees with a data entry within the reorganized data from processing portion 204, or disagrees with the weighting factor, e.g., the expert believes that the level of crime within a locality is more important than the median income. In such a case, the expert may be given an ability to change the data or change the algorithm. Processing portion 504 will recognize a level of access that the expert has been provided. This access may be established by way of any known security method or system. Once recognized, processing portion 206 will enable an expert to change a data entry or the algorithm. As such the reorganized data from processing portion 204 will now be again reorganized or changed, based on the changes made by the expert.

Processing portion 504 includes the original algorithm as was provided in processing portion 404 of FIG. 4, for arranging the data into an original format. However, as mentioned above, processing portion 504 may be able to modify the algorithm based on input from an expert from network of experts 108.

Interface portion 506 enables a system designer to create and or modify the algorithm within processing portion 504. Non-limiting examples of interface portion 506 include a keyboard, mouse and graphical user interface. Interface portion 506 may instruct processing portion 504 (to create and or modify the algorithm) by any known method, non-limiting examples of which include wireless and wired, as indicated by line 512.

Memory portion 508 is operable to store data, such as the reorganized data as received from processing portion 204 and the data reorganized by processing portion 504. Finally, memory portion 508 is able to provide the data reorganized by processing portion 504 or the reorganized data (as reorganized by processing portion 504 based on instructions from network of experts 108) to transceiver portion 502, based on an instruction from processing portion 504. In this manner, the reorganized data may be provided to processing portion 208 as indicated by line 222.

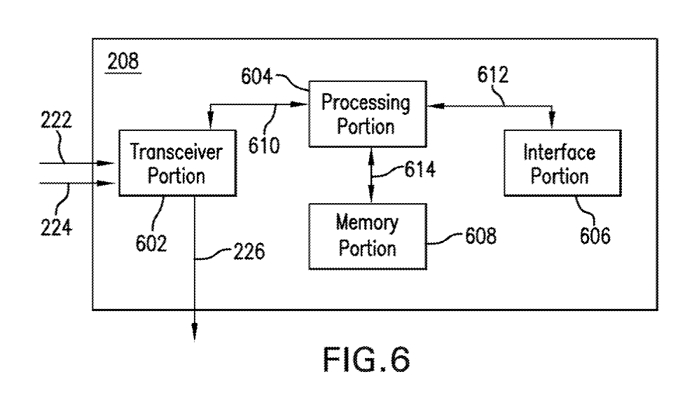

FIG. 6 illustrates processing portion 208 of the data managing portion 104 of FIG. 2. Processing portion 208 includes a transceiver portion 602, a processing portion 604, an interface portion 606 and a memory portion 608. In this embodiment, each of transceiver portion 602, processing portion 604, interface portion 606 and memory portion 608 are illustrated as distinct devices. However, in other embodiments, at least two of transceiver portion 602, processing portion 604, interface portion 606 and memory portion 608 may be combined as a unitary device. Further, in some embodiments, at least one of transceiver portion 602, processing portion 604, interface portion 606 and memory portion 608 may be implemented as a tangible computer-readable media for carrying or having computer-executable instructions or data structures stored thereon.

Transceiver portion 602 may be able to transmit and receive information by any known method, non-limiting examples of which include wireless and wired. Transceiver portion 602 may receive reorganized data from processing portion 206, as indicated by line 222. Transceiver portion 602 may than provide the reorganized data to processing portion 604 by any known method, non-limiting examples of which include wireless and wired, as indicated by line 610. Transceiver portion 602 may additionally provide the data from processing portion 206 to network of end users 110, as indicated by line 226.

For purposes of discussion, suppose an end user from network of end users 110 decides that quality of schools arc not an important aspect in determining an overall quality of a locality, whereas the number and quality of restaurants are. In such a case, the end user will have an ability to remove data values corresponding to the quality of schools from the data within memory portion 608. Further, processing portion 604 will reprocess the data without the data values corresponding to the quality of schools. The newly organized data may then be provided to the end user via transceiver portion 602. It should be noted that the main data within memory portion 608 is not changed, only the data set aside for the particular end user. As such, another end user from network of end users 110 will still have access to all the data. Further, another end user from network of end users 110 may decide to remove other types of data values, or indicate that specific aspects are more important than others. Processing portion will provide individual access to the master data within memory portion 608 accordingly. This access may be established by way of any known security method or system.

Processing portion 604 includes the original algorithm as was provided in processing portion 504 of FIG. 5, for arranging the data into an original format. However, as mentioned above, processing portion 604 may be able to modify the algorithm based on input from an end user from network of end users 110.

Interface portion 606 enables a system designer to create and or modify the algorithm within processing portion 604. Non-limiting examples of interface portion 606 include a keyboard, mouse and graphical user interface. Interface portion 606 may instruct processing portion 604 (to create and or modify the algorithm) by any known method, non-limiting examples of which include wireless and wired, as indicated by line 612.

Memory portion 608 is operable to store data, such as the reorganized data as received from processing portion 206 and the data reorganized by processing portion 604. Finally, memory portion 608 is able to provide the data reorganized by processing portion 604 or the reorganized data (as reorganized by processing portion 604 based on instructions from network of end users 108) to transceiver portion 602, based on an instruction from processing portion 604.

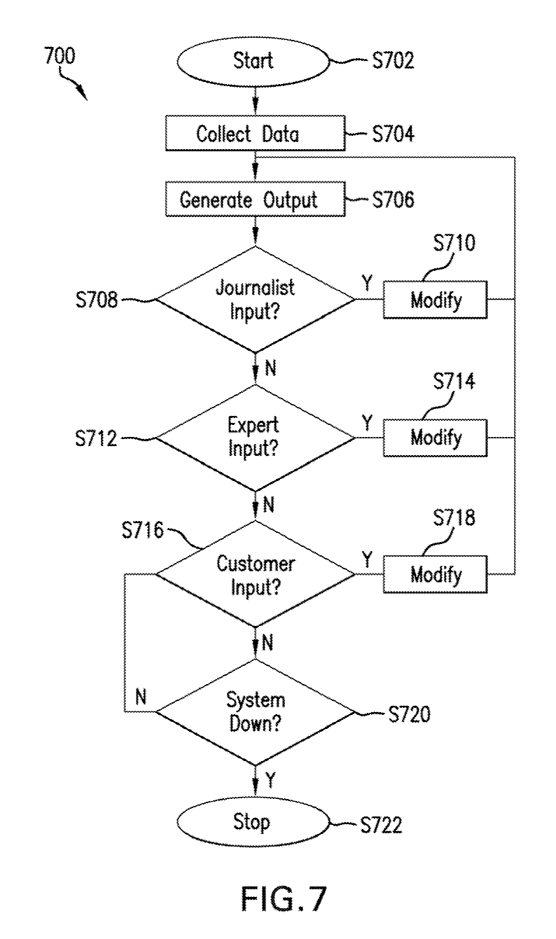

FIG. 7 is a flow chart describing an example method 700 of organizing, accessing an modifying data in accordance with aspects of the present invention.

As illustrated in the figures, method 700 starts (S702) and data is collected (S704). For example, as discussed above with reference to FIG. 1, data providing portion 102 provides data to data managing portion 104.

Then, the data is organized and output (S706). For example, as discussed above with reference to FIGS. 2 and 3, processing portion 202 organizes the data provided by data providing portion 102.

It is then determined whether a journalist provides input (S708). If so, then (for example as discussed above with reference to FIG. 4), at least one of the data and the algorithm used to organize the data is modified. Then the data is reorganized based on the input (S706).

If it is determined that a journalist does not provide input (S708), then it is determined whether an expert provides input (S712). If so, then (for example as discussed above with reference to FIG. 5), at least one of the data and the algorithm used to organize the data is modified. Then the data is reorganized based on the input (S706).

If it is determined that an expert does not provide input (S712), then it is determined whether an end user provides input (S716). If so, then (for example as discussed above with reference to FIG. 6), at least one of the data and the algorithm used to organize the data is modified. Then the data is reorganized based on the input (S706).

If it is determined that an end user does not provide input (S762), then it is determined whether the system is down (S720). If so, then method 700 stops (S722). If not, then method 700 waits for an end-user input (S716).

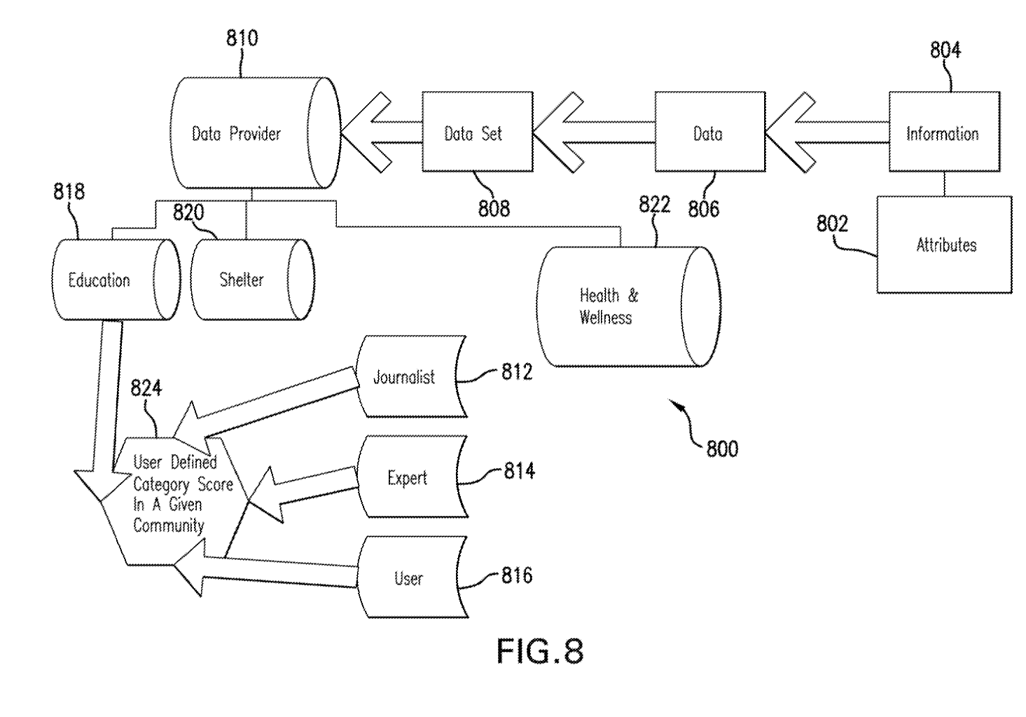

FIG. 8 illustrates another example system 800 for organizing, accessing and modifying data in accordance with aspects of the present invention.

As shown in the figure, system 800 includes an attribute defining portion 802, an information gathering portion 804, a data gathering portion 806, a data set creating portion 808, a data provider 810, accessible data set portions 818, 820 and 822, a network of journalists 812, a network of experts 814 a network of end-users 816, and a user defined data set 824.

For purposes of discussion, in this example: data provider 810 corresponds to data providing portion 102 of FIG. 1; the set of accessible data set portions 818, 820 and 822 and user defined data set 824 corresponds to data managing portion 104 of FIG. 1; network of journalists 812 corresponds to network of journalists 106 of FIG. 1; network of experts 814 corresponds to network of experts 108 of FIG. 1; and network of end-users 816 corresponds to network of end-users 110 of FIG. 1.

In this example, information gathering portion 804 gathers information of attributes from attribute defining portion 802. For example, attribute defining portion 802 may include attributes of some person, place or event. Places may include national, state or local locales. Non-limiting examples of attributes of a locale include education, housing and population health. Gathering portion 804 may include any known information gathering system operable to access and collect information regarding the attributes, non-limiting examples of which include manual information gathering and scanning into a computer system.

Once the information is gathered, data gathering portion 806 transforms the gathered information into useable data. Data gathering portion 806 may include any known data mining system. At this point, data set creating portion 808 creates data sets of the data. For example, data set creating portion 808 may create data sets of schools, houses and population wellness. All the created data sets are then provided to data provider 810.

Data provider 810 then makes the data available to network of journalists 812, network of experts 814 and network of end-users 816, as discussed above. For purposes of discussion, in this example, presume that a user within network of users 816 had previously indicated that Greenacre was of interest and the attributes of Greenacre to be scored were education, housing and wellness. As such, data provider 810 has generated accessible data set portion 818 corresponding to middle school test scores in a locale Greenacre, accessible data set portion 820 corresponding to housing foreclosures in Greenacre, and accessible data set portion 822 corresponding to a number of available hospital beds in Greenacre.

In this example, data provider 810 generates a score for Greenacre based on the data within accessible data set portions 818, 820 and 822, wherein the score is provided in user defined data set 824.

In accordance with an aspect of the present invention, a journalist within network of journalists 812 may access/change data within data provider 810 so as to affect the score provided in user defined data set 824. Similarly, an expert within network of experts 814 may additionally access/change data within data provider 810 so as to affect the score provide in user defined data set 824.

Many conventional systems or services may judge/rank persons/places/events based on predefined criteria or attributes. However, as mentioned previously, these conventional systems are static.

In accordance with aspects of the present invention, an initial data set is created to judge/rank persons/places/events based on predefined criteria or attributes. However, contrary to conventional systems or services, in accordance with aspects of the present invention, a first group of people have a first level of access to the initial data. This first level of access enables the first group to modify the initial data set and/or modify the algorithm used to judge/rank the data within the data set. Further, a second group of people have a second level of access to initial data and to the data as modified by the first group of people. Finally, an end user has a third level of access to the data as modified by the first group of people and the second group of people. Further, an end user has an ability to remove attributes for consideration in the ranking/judging.

Aspects of the present invention provide a system and service for providing a dynamically updating data set for ranking/judging based on predetermined criteria.

The foregoing description of various preferred embodiments of the invention have been presented for purposes of illustration and description. It is not intended to be exhaustive or to limit the invention to the precise forms disclosed, and obviously many modifications and variations arc possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A system for use with a data providing portion, a first user device, a second user device and a third user device, the data providing portion being operable to provide initial data having a plurality of data entries, said system comprising:
a first processing portion operable to generate a ranking of the plurality of data entries based on a predetermined weighting factor;
a second processing portion operable to provide the first user device with a first level of access to the ranking, to change one of the plurality of data entries, the ranking and the predetermined weighting factor and to generate a second ranking based on the changed one of the plurality of data entries, the ranking and the predetermined weighting factor;
a third processing portion operable to provide the second user device with a second level of access to one of the ranking and the second ranking; and
a fourth processing portion operable to provide the third user device with a third level of access to one of the ranking and the second ranking.

2. The system of claim 1,
wherein said third processing portion is further operable to change one of the plurality of data entries, the ranking, the second ranking and the predetermined weighting factor and to generate a third ranking based on the changed one of the plurality of data entries, the ranking, the second ranking and the predetermined weighting factor, and
wherein said fourth processing portion is further operable to provide the third user device with the third level of access to one of the ranking, the second ranking and the third ranking.

3. The system of claim 1, wherein said first processing portion is further operable to generate the ranking of the plurality of data entries based additionally on a second predetermined weighting factor.

4. The system of claim 3, wherein the predetermined weighting factor has a first magnitude and the second predetermined weighting factor has a second magnitude.

5. The system of claim 4, wherein the first magnitude is different from the second magnitude.

6. The system of claim 5, wherein the first magnitude is greater than the second magnitude.

7. The system of claim 6, wherein said second processing portion is further operable to change the predetermined weighting factor by changing one of the first magnitude and the second magnitude.

8. The system of claim 6,
wherein said third processing portion is further operable to change one of the plurality of data entries, the ranking, the second ranking and the predetermined weighting factor and to generate a third ranking based on the changed one of the plurality of data entries, the ranking, the second ranking and the predetermined weighting factor, and
wherein said fourth processing portion is further operable to provide the third user device with the third level of access to one of the ranking, the second ranking and the third ranking.

9. The system of claim 8, wherein said third processing portion is further operable to change the predetermined weighting factor by changing one of the first magnitude and the second magnitude.

10. A method of using a data providing portion, a first user device, a second user device and a third user device, the data providing portion being operable to provide initial data having a plurality of data entries, said method comprising:
generating, via a first processing portion, a ranking of the plurality of data entries based on a predetermined weighting factor;
providing, via a second processing portion, the first user device with a first level of access to the ranking;
changing, via the second processing portion, one of the plurality of data entries, the ranking and the predetermined weighting factor;
generating, via the second processing portion, a second ranking based on the changed one of the plurality of data entries, the ranking and the predetermined weighting factor;
providing, via a third processing portion, the second user device with a second level of access to one of the ranking and the second ranking; and
providing, via a fourth processing portion, the third user device with a third level of access to one of the ranking and the second ranking.

11. The method of claim 10, further comprising:
changing, via the third processing portion, one of the plurality of data entries, the ranking, the second ranking and the predetermined weighting factor;
generating, via the third processing portion, a third ranking based on the changed one of the plurality of data entries, the ranking, the second ranking and the predetermined weighting factor; and
providing, via the fourth processing portion, the third user device with the third level of access to one of the ranking, the second ranking and the third ranking.

12. The method of claim 10, further comprising generating, via the first processing portion, the ranking of the plurality of data entries based additionally on a second predetermined weighting factor.

13. The method of claim 12, wherein the predetermined weighting factor has a first magnitude and the second predetermined weighting factor has a second magnitude.

14. The method of claim 13, wherein the first magnitude is different from the second magnitude.

15. The method of claim 14, wherein the first magnitude is greater than the second magnitude.

16. The method of claim 15, further comprising changing, via the second processing portion, the predetermined weighting factor by changing one of the first magnitude and the second magnitude.

17. The method of claim 15, further comprising:
changing, via the third processing portion, one of the plurality of data entries, the ranking, the second ranking and the predetermined weighting factor;
generating, via the third processing portion, a third ranking based on the changed one of the plurality of data entries, the ranking, the second ranking and the predetermined weighting factor; and
providing, via the fourth processing portion, the third user device with the third level of access to one of the ranking, the second ranking and the third ranking.

18. The method of claim 17, further comprising changing, via the third processing portion, the predetermined weighting factor by changing one of the first magnitude and the second magnitude.
